(19) United States
(12) Patent Application Publication
(10) Pub. No.: US 2026/0119174 A1
(43) Pub. Date: Apr. 30, 2026

(54) Semiconductor Apparatus, Semiconductor Device, Method for a Semiconductor Device, and Non-Transitory Computer-Readable Medium, Method, Apparatus and Device for a Computer System

(71) Applicants: Kermin CHOFLEMING, Hudson, MA (US); Tuan QUACH, San Clemente, CA (US); William LEE, Sherwood, OR (US); Mitchell DIAMOND, Shrewsbury, MA (US); Nanda G Kumar KALAVAI, Fair Oaks, CA (US)

(72) Inventors: Kermin CHOFLEMING, Hudson, MA (US); Tuan QUACH, San Clemente, CA (US); William LEE, Sherwood, OR (US); Mitchell DIAMOND, Shrewsbury, MA (US); Nanda G Kumar KALAVAI, Fair Oaks, CA (US)

(21) Appl. No.: 19/429,691

(22) Filed: Dec. 22, 2025

Related U.S. Application Data
(60) Provisional application No. 63/913,180, filed on Nov. 7, 2025.

(51) Int. Cl. G06F 9/30

(52) U.S. Cl. CPC G06F 9/3005; G06F 9/30047

(57) ABSTRACT

Various examples relate to a semiconductor apparatus, or to a non-transitory computer-readable medium, a method, an apparatus or a device for a computer system, and to a computer system comprising the semiconductor apparatus and the apparatus or device. A semiconductor apparatus comprises interface circuitry for obtaining a dataflow graph comprising a plurality of nodes, and a plurality of processing elements, an interconnect network coupled to the plurality of processing elements and configured to receive an input of the dataflow graph, wherein the dataflow graph is to configure the interconnect network and the plurality of processing elements, wherein the processing elements are to perform a plurality of operations defined by the nodes of dataflow graph, wherein the dataflow graph comprises a first type of node for performing a computation and a second type of node for determining a branching condition, wherein the semiconductor apparatus is configured to, upon determining a result of a branching condition specified by a node having the second type, configure the interconnect network and the processing elements based on the result of the branching condition.

### CROSS-REFERENCE TO RELATED APPLICATION

This application claims the benefit of priority under 35 U.S.C. § 119(e) to U.S. Provisional Application No. 63/913,180, filed on Nov. 7, 2025, the entire contents of which are hereby incorporated by reference.

### STATEMENT OF GOVERNMENT INTEREST

This invention was made with Government support under Agreement No. HR0011-24-9-0302, awarded by the Defense Advanced Research Projects Agency (DARPA). The Government has certain rights in the invention.

### BACKGROUND

Spatial accelerators, such as the Intel® Configurable Spatial Accelerator (CSA), are specialized hardware architectures designed to improve performance and energy efficiency for specific computational workloads. Unlike traditional processors that execute instructions sequentially, spatial accelerators implement computation by mapping dataflow graphs directly onto reconfigurable hardware fabric. These accelerators typically comprise an array of processing elements (PEs) interconnected through a configurable network, allowing data to flow spatially across the architecture rather than being shuttled back and forth to memory.

Programs are executed on spatial accelerators by first compiling the high-level code into a dataflow graph representation that explicitly captures the parallelism and data dependencies in the computation. This dataflow graph is then mapped onto the accelerator's fabric, where nodes become processing elements and edges become data channels. The compiler configures the accelerator hardware to implement the specific operations and routing required for the program. During execution, data streams through the configured fabric in a pipelined fashion, with multiple operations proceeding concurrently as data becomes available, eliminating much of the overhead associated with instruction fetch and decode in traditional architectures.

### BRIEF DESCRIPTION OF THE FIGURES

Some examples of apparatuses and/or methods will be described in the following, by way of example only, and with reference to the accompanying figures, in which:

FIG. 1a shows a schematic diagram of a tile of a spatial accelerator semiconductor apparatus or semiconductor device;

FIG. 1b shows a schematic diagram of a computer system comprising a spatial accelerator semiconductor apparatus or semiconductor device with a plurality of tiles;

FIG. 1c shows a flowchart of a method for a spatial accelerator semiconductor device and for a computer system;

FIG. 2 shows a classical control-dataflow graph;

FIG. 3 shows an illustration of a graph decision tree including decision-making sub-programs (“Deciders”) and non-decision making sub-programs (“Analysis”);

FIG. 4 shows a C/C++ pseudocode of the proposed (multi-way) branching structure;

FIG. 5 illustrates an organization of command RAM for wide switching;

FIG. 6 illustrates an augmentation to fast configuration FSM to support decider-directed branching;

FIG. 7 shows an illustration of wide branch support for subtiles;

FIG. 8 shows a Feynman diagram illustrating fast branch flow;

FIG. 9 shows an example of cooperative pre-emption;

FIG. 10 shows a decision “tree” involving a complex looping structure;

FIG. 11 illustrates a low-level microarchitectural view of the fast-branching architecture;

FIG. 12 shows a branching flow test topology;

FIG. 13 shows a timing waveform of a branch graph and a target graph;

FIG. 14 shows a RTL-derived waveform timing of a branch with data locality; and

FIG. 15 shows a schematic diagram of a computer system.

### DETAILED DESCRIPTION

Some examples are now described in more detail with reference to the enclosed figures. However, other possible examples are not limited to the features of these embodiments described in detail. Other examples may include modifications of the features, as well as equivalents and alternatives to the features. Furthermore, the terminology used herein to describe certain examples should not be restrictive of further possible examples.

Throughout the description of the figures, the same or similar reference numerals refer to the same or similar elements and/or features, which may be identical or implemented in a modified form while providing the same or a similar function. The thickness of lines, layers and/or areas in the figures may also be exaggerated for clarification.

When two elements A and B are combined using an “or”, this is to be understood as disclosing all possible combinations, i.e. only A, only B as well as A and B, unless expressly defined otherwise in the individual case. As an alternative wording for the same combinations, “at least one of A and B” or “A and/or B” may be used. This applies equivalently to combinations of more than two elements.

If a singular form such as “a”, “an”, or “the” is used and the use of only a single element is not defined as mandatory either explicitly or implicitly, further examples may also use several elements to implement the same function. If a function is described below as implemented using multiple elements, further examples may implement the same function using a single element or a single processing entity. It is further understood that the terms “include”, “including”, “comprise” and/or “comprising”, when used, describe the presence of the specified features, integers, steps, operations, processes, elements, components and/or a group thereof, but do not exclude the presence or addition of one or more other features, integers, steps, operations, processes, elements, components and/or a group thereof.

Various examples of the present disclosure relate to generalized branching in accelerators. The present disclosure relates to a semiconductor apparatus or semiconductor device, e.g., a spatial accelerator semiconductor apparatus or semiconductor device, engineered for high-performance computing. For example, the proposed semiconductor apparatus may be implemented on the Intel® Configurable Spatial Accelerator (CSA) platform. The architecture of the proposed semiconductor apparatus, which may be implemented similar to the CSA, is a departure from traditional processors that execute a linear sequence of instructions. Instead, this apparatus is designed to be physically configured to directly mirror the structure of a computation, allowing for massive parallelism.

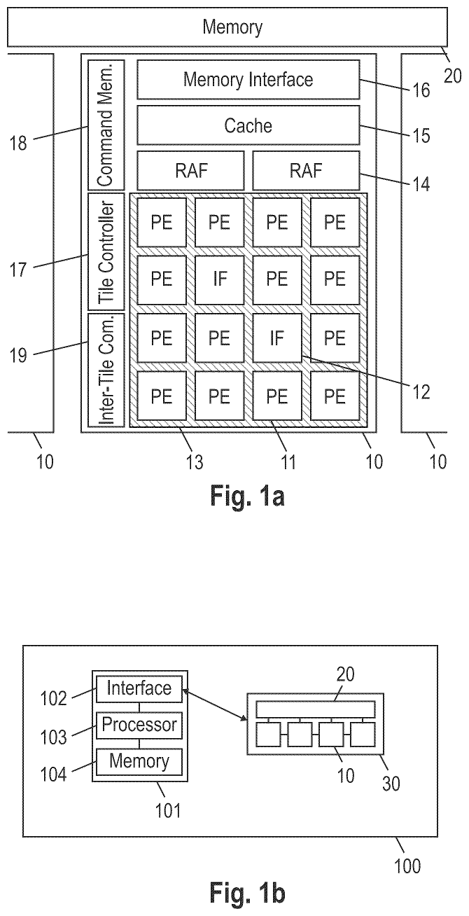

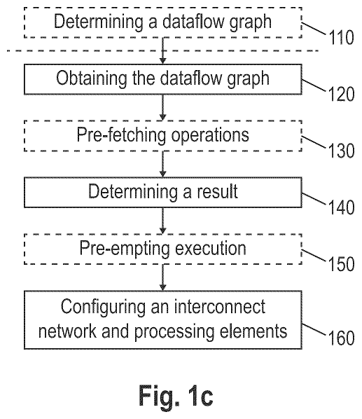

FIG. 1a shows a schematic diagram of a tile 10 of a spatial accelerator semiconductor apparatus or semiconductor device. The tile comprises a plurality of processing elements (PE) 11, which are interconnected by an interconnect network 13. In addition to the processing elements 11, the interconnect network 13 may also connect interface elements (IF) 12 to the processing elements, to enable communication with other devices. The tile further comprises a RAF (Request Address File) 14, which manages memory accesses by the processing elements 11. The tile further comprises a cache 15 and a memory interface 16, with the RAF 14 coordinating the access to memory 20 via the memory interface 16 and the cache 15. As further optional components, the tile comprises a tile controller 17, which may be used to configure the PEs 11 and interconnect network 13, e.g., with the help of the RAFs 14, a command memory 18, and an inter-tile communication interface 19, which enables communication between the tiles 10 of the spatial accelerator semiconductor apparatus or semiconductor device. The tile controller 17 may serve as interface circuitry or interface for obtaining a dataflow graph comprising a plurality of nodes, which defines the functionality of the spatial accelerator semiconductor apparatus or semiconductor device. The interconnect network 13 is coupled to the processing elements and configured to receive an input of the dataflow graph. In particular, the dataflow graph is to configure the interconnect network 13 and the plurality of processing elements 11. The processing elements 13 are to perform a plurality of operations defined by the nodes of dataflow graph.

FIG. 1b shows a schematic diagram of a computer system 100 comprising a spatial accelerator semiconductor apparatus 30 or semiconductor device 30 with a plurality of tiles 10 and a memory 20. In addition to the spatial accelerator semiconductor apparatus 30 or semiconductor device 30, the computer system 100 comprises a conventional apparatus or device 101 comprising an interface circuitry 102 or means for communicating 102, processor circuitry 103 or means for processing 103, and memory circuitry 104 or means for storing information 104. The apparatus 101 comprises circuitry configured to perform the functionality of the apparatus. In particular, the apparatus 101 comprises the interface circuitry 102, the processor circuitry 103, and the memory circuitry 104. The processor circuitry 103 is coupled with the interface circuitry 102 and the memory circuitry 104 and configured to provide the functionality of the apparatus 101, with the help of the interface circuitry 102 (for exchanging information, e.g., with the semiconductor apparatus 30) and the memory circuitry 104 (for storing information, such as machine-readable instructions or the dataflow graph). For example, the processor circuitry 103 may be configured to execute machine-readable instructions that define the functionality performed by the apparatus 101. Similarly, the components of the device 101 are defined as component means, which may be implemented by the corresponding components of the apparatus 101. The functionality of the device 101 may be substantially the same as the functionality of the apparatus 101.

The fundamental programming abstraction for the spatial accelerator semiconductor apparatus 30, or device 30, is the dataflow graph. This graph is a formal representation of a program, where the task is broken down into a collection of nodes and edges. The nodes represent specific operations, such as an arithmetic calculation, a logical comparison, or a memory access. The edges connecting these nodes represent the dependencies between them, dictating the path that data follows. For instance, an edge from a “load” node to an “add” node signifies that the data retrieved from memory is required for the addition operation. This model makes the inherent parallelism of an application explicit.

The physical hardware of the apparatus is designed to execute the dataflow graph. The spatial accelerator semiconductor apparatus or device comprises a plurality of processing elements (PEs) 11, e.g., a spatial array of processing elements. These are the computational circuits performing the computational tasks of the system, each responsible for executing the operation of a single node from the dataflow graph. The PEs are often heterogeneous, meaning they can be specialized for different types of tasks (e.g., some for floating-point math, others for integer logic).

Connecting these processing elements is the interconnect network 13. This network acts as the circulatory system of the apparatus, responsible for routing data between the PEs according to the edges defined in the dataflow graph. A key characteristic of this network is that its communication channels may be implemented “latency-insensitive” and “back-pressured.”This means the system may operate correctly regardless of communication delays, as a PE may automatically pause and wait to send data until the receiving PE has available space. This data-driven, asynchronous model may ensure reliable operation without requiring a global clock to synchronize every action across the chip.

The process of preparing the apparatus for a task is called configuration. During this phase, the dataflow graph is loaded onto the hardware (e.g., using the tile manager 17 and/or the RAFs 14). The definitions for the graph's nodes and edges may be stored in the command memory 18. The configuration process reads this information and uses it to program the individual PEs (by assigning the respective PEs a specific operation to perform) and to set up the data pathways within the interconnect network. Once configured, the spatial accelerator semiconductor apparatus or device is transformed into a specialized hardware circuit custom-built for that specific dataflow graph.

To manage the high volume of memory accesses that occur in such a parallel system, the apparatus may rely on specialized memory interface components. The cache 15 may be employed as a high-speed buffer between the processing elements 11 and the memory 20. It may store frequently accessed data and instructions, thereby reducing the latency of memory operations and keeping the PEs supplied with the data they need to continue operating without stalls. Furthermore, the Request Address File (RAF) circuit 14 may be used to manage the flow of memory requests. In an environment with hundreds or thousands of PEs potentially accessing memory simultaneously, the RAF circuit may act as a traffic controller, orchestrating the memory load and store operations originating from across the PE array, helping to ensure data consistency and manage dependencies between memory accesses.

Most accelerator architectures do not support self-scheduling of the next work, relying instead on external control programs to supply subsequent work items. Reliance on external decision-making can introduce significant latency into processing and limit the usefulness of the accelerator. The proposed concept describes a branching architecture by which an accelerator can self-direct the next work based on its own execution, and, without an external control program in the decision loop, removing significant latency from the system.

The proposed concept introduces the concept of a branch into a command-queue-based accelerator architecture. The branch allows the accelerator to direct execution to different commands in the command queue based on dynamic decisions taken at the accelerator, enabling the accelerator to orchestrate complex control flows without the intervention of a host processor.

Present architectures require software-in-loop decision-making for accelerator control flow. The proposed techniques allow the accelerator to self-direct complex execution flows. In situations where kernel runtimes are short, such as signal processing or edge AI/ML, software-in-loop can significantly degrade application-level performance by increasing latency.

The CSA processor centers around the notion of executing kernels, which are individual components of a decision tree (i.e., the dataflow graph), as opposed to pieces of a decision tree. The proposed concept enables handling more general kernel flows with a complex and possibly dynamic structure.

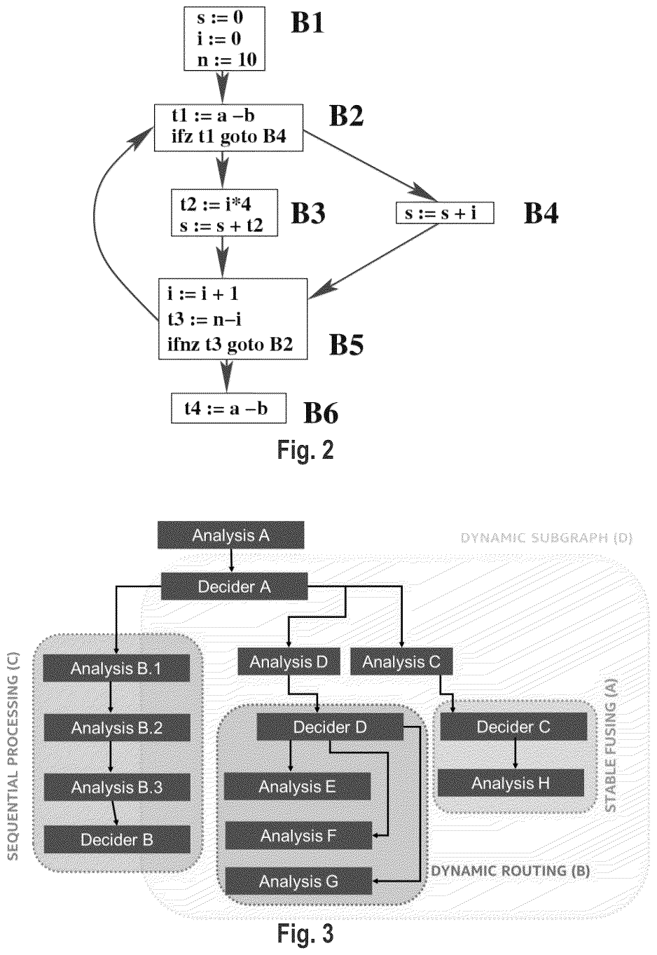

The key conceptual enabler to these flows is to consider the sequence of kernels executing on the RTRA (Run-Time Reconfigurable Array) as a very coarse-grained version of a control-dataflow graph (CDFG), as shown in FIG. 2. FIG. 2 shows a classical control-dataflow graph with six nodes B1-B6. In node B2, a branch is defined (if a−b=0, then go to B4, else go to B3). CDFG is commonly used inside of compilers to manage flow controls arising from programming languages. As such, CDFG is demonstrably capable of handling a vast range of potential control flows. While most CDFG analysis in conventional compilation focuses on basic blocks (e.g., instruction flows with a single exit/entry point), the concept can be extended to decision trees. In this conception the CDFG nodes would be the kernels of the tree. Support for this paradigm requires only a generic branch capability, which is what the CSA RTRA supports. The proposed branching mechanism is sufficient to support a CDFG-like paradigm for control of the CSA RTRA.

This approach bears some similarity to CUDA Streams and SYCL flow graphs, which allow a host program to launch a dependent set of GPU kernels with a single call. However, it extends the capability to express conditional execution and looping. The proposed approach also leverages a hardware engine, making it possible to completely eliminate costly synchronization between host and accelerator.

The present disclosure relates to a technique for configuring spatial accelerator semiconductor apparatus or device architectures to support dynamic branching in dataflow graph execution. In conventional dataflow processing architectures, the flow of execution is typically static, meaning that the configuration of processing elements and interconnect networks is predetermined and cannot adapt dynamically to runtime conditions or intermediate computation results without involving the host computer. This limitation restricts the ability to implement conditional execution, loops, and dynamic control flow, which are essential for many advanced computational tasks. Various examples of the present disclosure are based on the finding that by incorporating branching nodes within dataflow graphs and enabling the spatial accelerator semiconductor apparatus or device to reconfigure its interconnect network and processing elements based on branching conditions determined at runtime, the system can support flexible, efficient execution of complex computational workflows that require conditional logic and dynamic control flow.

The proposed concept provides a spatial accelerator semiconductor apparatus or device, that processes dataflow graphs comprising both computation nodes and branching condition nodes. By evaluating branching conditions during execution and dynamically reconfiguring the hardware resources based on the results, the apparatus enables efficient implementation of conditional execution paths and iterative operations. This improves the flexibility and computational efficiency of dataflow-based processing architectures, allowing them to handle a wider range of computational tasks while maintaining the parallelism and energy efficiency advantages of dataflow execution models. The proposed concept results in a more versatile processing architecture capable of executing complex algorithms that require runtime decision-making without sacrificing the performance benefits of specialized dataflow hardware.

To enable branch support, the dataflow graph comprises a first type of node for performing a computation (e.g., each of nodes B1, B3 to B6 in FIG. 2) and a second type of node for determining a branching condition (e.g., node B2). While node B2 in FIG. 2 also includes a computation, this computation is merely used for the branching decision. The spatial accelerator semiconductor apparatus 30 or spatial accelerator semiconductor device 30 is configured to, upon determining the result of a branching condition specified by a node having the second type, configure the interconnect network and the processing elements based on the result of the branching condition. In this way, the spatial accelerator may be reconfigured without requiring involvement of the classical processor of the computer system, speeding up the reconfiguration. By incorporating branching condition nodes into the dataflow graph and enabling dynamic reconfiguration based on branching results, the spatial accelerator semiconductor apparatus or device achieves flexible control flow execution within a dataflow architecture, thereby combining the parallelism benefits of dataflow processing with the versatility of conditional execution.

FIG. 1c shows a flowchart of a method for the spatial accelerator semiconductor apparatus/device 30 and for the computer system 100. From the perspective of the computer system, the method comprises determining 110 the dataflow graph for the semiconductor apparatus 30 or semiconductor device; the dataflow graph comprises the first type of node for performing a computation and the second type of node for determining a branching condition. From the perspective of the semiconductor apparatus or device 30, the method comprises obtaining 120 the dataflow graph, and, upon determining 140 a result of a branching condition specified by a node having the second type, configuring 160 the interconnect network and the processing elements based on the result of the branching condition.

In the following, the features of the semiconductor apparatus 30, semiconductor device 30, computer system 100, methods, and corresponding computer programs will be discussed in more detail with reference to the semiconductor apparatus 30. Features discussed in connection with the semiconductor apparatus 30 may likewise be included in the corresponding semiconductor device 30, computer system 100, methods, and computer programs.

Various examples of the present disclosure support multi-way branching. The nomenclature of a multi-way branch is framed according to the hypothetical decision tree shown in FIG. 3. FIG. 3 shows an illustration of a graph decision tree including decision-making sub-programs (“Deciders”) and non-decision-making sub-programs (“Analysis”). In this decision tree, there are two types of nodes. “Analysis” nodes, which may correspond to nodes of the first type, do not have decisions. They represent pipelines of unconditional processing on an input. “Decider” nodes, which may correspond to nodes of the second type, result in the selection of one (or more) subsequent processing paths based on computation performed in the node. Deciders can be combined with “Analysis” nodes to increase their run length (e.g., an FFT followed by a power detection) or with other Deciders to form an even wider branch point. All nodes in the present decision tree fit into one of these two categories. In this section, we describe an architecture that allows Deciders to rapidly branch to new analysis paths, without involvement of firmware on the critical path. The proposed concept supports more complex decision-tree topologies, including nested branches.

As is evident from “Decider A” in FIG. 3, in some cases a branch may lead to more than two other nodes (Analysis B.1, Analysis C and Analysis D in the case of Decider A). Thus, to support multi-way branching and complex decision trees, in various examples the branching condition may specify two or more nodes of the dataflow graph or of one or more different dataflow graphs to be used for configuring the interconnect network and the processing elements. This capability enables the semiconductor apparatus to select among multiple execution paths based on the branching condition, thereby supporting sophisticated control flow patterns beyond simple binary decisions.

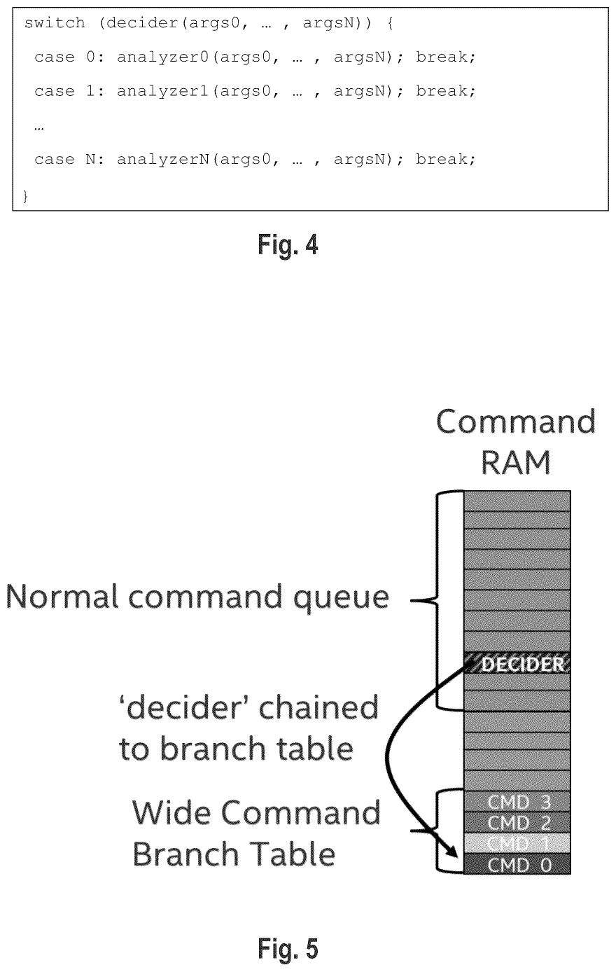

A basic approach to handling branches is analogous to “switch” statements in C/C++, in which an index is provided that branches to several different code blocks to handle the switch. In the context of a decision tree, this means that the decider will determine which analysis path to pursue and cause a branch to that analysis upon its conclusion. FIG. 4 shows a C/C++ pseudocode (logical C/C++ equivalent) of the proposed (multi-way) branching structure. A decision index determined by the decider drives the branching decision. While the decider is depicted as solely providing a decision as a return value, in reality it can provide multiple outputs, including arguments for subsequent analyzer routines.

FIG. 5 illustrates an organization of command RAM for wide switching. A decider may branch into a pre-populated branch table in the command RAM. Although commands are shown as single entries, they may involve multiple 8B words (e.g., including arguments). The proposed approach to branching closely follows the structure of FIG. 4, as illustrated in FIG. 5. Normally, CSA commands are populated in a command queue that is traversed linearly by the tile manager. This arrangement works well for sequences of non-decision processing, as the tile manager can simply process the next command in the command queue. For example, in FIG. 4, the “DECIDER” command is in the normal command queue and will be processed when it reaches the command queue head as normal.

The handling of the decider itself follows a slightly different flow. The decider can branch to one of several other commands. These commands are placed in a branch table outside of the command queue. In other words, the nodes of the dataflow graph may be stored in a command queue, and the semiconductor apparatus may be configured to jump from the branching condition node to an entry in a branch table that is separate from the command queue. This separation allows for more flexible control flow management and enables the branching logic to be maintained independently of the sequential command structure. A side effect of the decider executing is that the decider must produce one and only one ‘decision’ result. The decision result is an index into the command branch table. The resolution of a command RAM (Random Access Memory) pointer requires a lookup in a table mapping indexes to locations in the command RAM. This indirection structure was chosen as it decouples a compiled graph (framed in abstracted indices) from physical knowledge of the command RAM layout being targeted. Thus, the entry in the branch table may define an offset with respect to a command memory for referencing nodes of the dataflow graph or of a different dataflow graph. This enables the semiconductor apparatus to navigate to arbitrary locations in the command memory, thereby supporting complex branching scenarios including transitions between different computational workflows. The semiconductor apparatus may then be configured to set up the interconnect network and the processing elements based on the entry in the branch table and the offset with respect to the command memory. By utilizing both the branch table entry and the offset information, the apparatus achieves precise control over which nodes of the dataflow graph are executed following a branching decision, thereby enabling accurate implementation of conditional execution paths. In some examples, the branch table may be configured to support nested branching by specifying a node referred to by an entry in the branch table that is also a node of the second type for determining a further branching condition. This nested branching capability enables the implementation of sophisticated algorithms that require hierarchical decision-making structures.

The ‘decision’ result can be produced at any time during the execution of a graph, including well before the completion of that graph's execution, and can trigger the start of the graph switching at the time it is produced, without having to wait for the decider graph to complete execution (thanks to the separate completion buffer architecture). In other words, the semiconductor apparatus may be configured to initiate the configuration of the interconnect network and the processing elements based on the result of the branching condition before the execution of the dataflow graph containing the node of the second type has completed. This early initiation of reconfiguration enables the apparatus to begin setting up the next stage of execution while still completing previous operations, thereby achieving better pipeline efficiency.

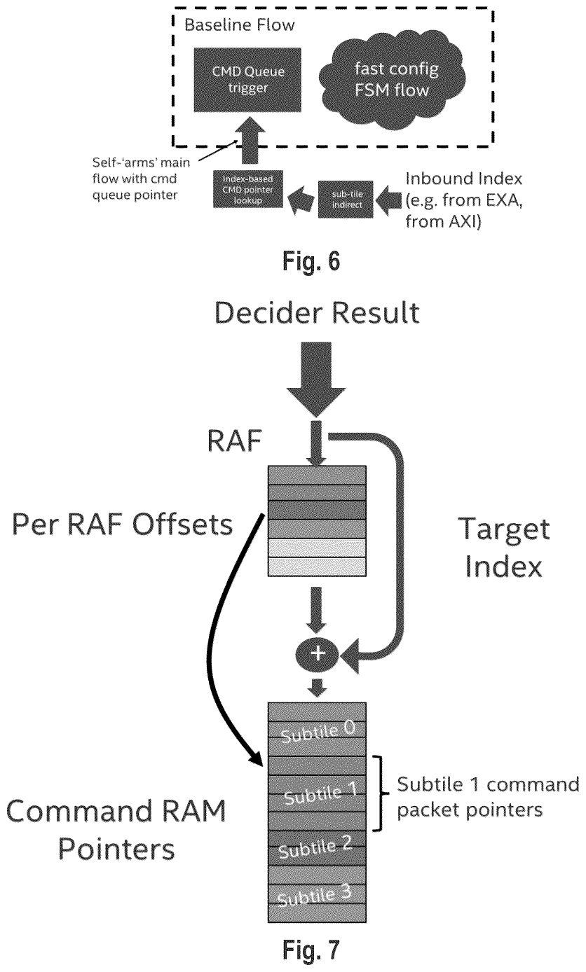

The decision result provided by the executing graph describes the index of the command in the branch command table that is chosen, and a table at the tile manager is accessed by way of this index. The ‘decision’ result can be used to trigger the fast configuration FSM, resulting in a fast configuration flow, the latency of which is similar to command-queue-driven fast configurations. This flow is depicted in FIG. 6 in which an inbound index from the running graph causes the fast configuration FSM to be armed and pointing to the command packet associated with the branch index. FIG. 6 illustrates an augmentation to the fast configuration FSM to support decider-directed branching. An index provided by a decider executing on the processor may trigger the execution of a subsequent branch command. In other respects, the decision is just another result of the graph, and it is eventually returned to software, for example to arrange further processing along the branch.

Further processing follows the branch command; for example, there may be another branch, but it typically results in control returning to the command queue upon termination of the branch target. Commands in the branch table are the same as commands in the main command queue in terms of form and handling. Thus, these commands can follow any command format, including both fast configuration and slow configuration. The proposed branch table arrangement naturally supports complex arrangements of commands, including nested branching, and the commands in the branch table may themselves also be deciders.

The decision result packet may bypass the standard result queue, triggering the configuration mechanism more rapidly. This means that the configuration fetching (the main latency driver) can commence prior to the completion of processing of prior graph results at TMGR, or even before the complete collection of results, including memory ordering. In other words, a decision result packet indicating the result of the branching condition may be configured to bypass a result queue to trigger the configuration of the interconnect network and the processing elements. By bypassing the result queue, the branching decision is communicated more rapidly to the configuration logic, thereby reducing the latency between determining the branching condition and implementing the corresponding hardware reconfiguration.

FIG. 7 shows an illustration of wide branch support for subtiles. Command packets are associated with the RAF, producing the decider result, allowing each subtile to branch independently.

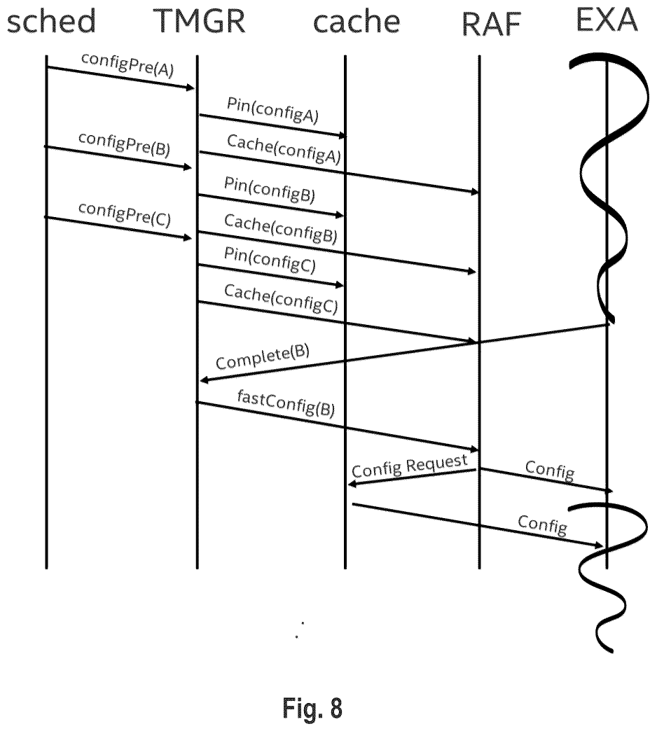

FIG. 8 shows a Feynman diagram illustrating fast branch flow. The branch flow is performed across a scheduler (sched), the tile manager (TMGR), the cache, the RAF, and the PEs (included in the EXA). In preparation for the different outcomes (A, B, or C) of the branching decision, the scheduler triggers the tile manager to pin the respective configurations in the cache and to cause the RAF to cache them.

A decider graph indicates which next graph to execute (in this case graph B is chosen), indicated by the Complete (B) message from EXA to the tile manager. The tile manager then initiates fast configuration of configuration B at the RAF, which sends a configuration request to the cache and the configuration to the EXA.

In FIG. 8, it is shown that the semiconductor apparatus (e.g., the tile manager and/or the scheduler) may be configured to pre-fetch operations associated with nodes being referred to by the branching-condition node into the cache memory. Accordingly, the method of FIG. 1c may comprise pre-fetching 130 the operations. By pre-fetching potential branch targets, the apparatus reduces the delay incurred when a branching decision is made, thereby improving overall execution performance. The respective reconfiguration may be applied by the RAF, which may be configured to configure the interconnect network and the processing elements based on the result of the branching condition.

Software sets up branch execution underneath accelerator execution, removing software from the execution critical path. FIG. 8 illustrates a dynamic flow for fast switching in terms of the messages sent. A first graph makes a branch decision based on its execution, which then triggers a reconfiguration to a second graph. Upper levels of software set up this flow, but do not participate in the inner decision loop.

Software-supplied metadata may be guarded by valid bits, thereby providing fine-grained synchronization with the hardware flow. This allows software to elide coarse-grained synchronization and to overlap branch setup and execution.

Various examples of the present disclosure support interrupts and cooperative pre-emption. In some cases, the CSA may be used to process ‘priority’ voxels/signals. These are signals which, when detected, need to be processed with minimal latency. For example, this could be a signal that has previously been identified as interesting. Across the stack, wideband spectrum sensing on the semiconductor apparatus may be treated as an oversubscribed symmetric multiprocessor, wherein the scheduler will keep the processors busy with work. In the baseline model, the scheduler may prioritize executing a voxel to completion on the same CSA processor (e.g., semiconductor apparatus or tile thereof), particularly to exploit cache locality and to conserve shared system resources such as memory bandwidth. While this model matches spectrum sensing well and essentially guarantees near 100% processor utilization, it does not completely handle rapid pivoting to priority voxels as these priority voxels must rapidly displace existing running voxels.

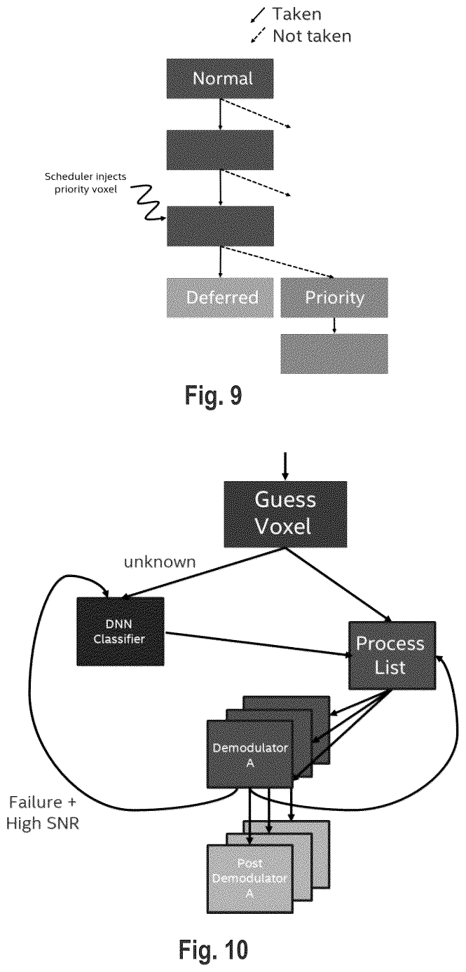

FIG. 9 shows an example of cooperative pre-emption of a normal-priority voxel by a high-priority voxel. Here, pre-emption is cast as a special case of a branch flow. FIG. 9 shows a decision-tree execution flow in which the scheduler has chosen to pre-empt the ongoing processing of a voxel to utilize the RTRA to execute a new priority voxel. In this case, the branching flow is used to implement pre-emption. Effectively, each kernel call may be considered a two-way branch in which execution can either proceed down the command queue (as normal) or branch to some new processing routines. In other words, the semiconductor apparatus may be configured to pre-empt execution of one or more nodes of the dataflow graph based on the result of the branching condition. Accordingly, the method of FIG. 1c may comprise pre-empting 150 execution of the one or more nodes. This pre-emption capability allows the apparatus to terminate or skip operations that are no longer needed due to branching decisions, thereby conserving processing resources and reducing energy consumption. For example, pre-emption may be implemented by evaluating the result of a branching condition after execution of a first-type node, with the branching condition being related to the pre-emption. By evaluating branching conditions at strategic points following computation nodes, the apparatus can make informed decisions about whether to continue or terminate subsequent operations, thereby achieving efficient pre-emption based on actual computation results.

The pre-emption branch decision may be made by having the kernel poll a location in memory that can be set by the scheduler if pre-emption is required. In other words, pre-emption may be triggered by polling a memory location that a scheduler sets to indicate a need for pre-emption. If pre-emption is detected, the CSA would follow its normal branch flow to the new execution stream. If no pre-emption is detected, the regular command flow, potentially including other branch choices, will be followed. In the case of a non-branching kernel, the non-pre-emption branch would simply point to the head of the command queue.

While branch decisions are typically considered to occur at the end of a computation, this is not a requirement. In a pre-emptive flow, the running kernel could periodically check for pre-emption and yield with low latency, for example by terminating its execution. Whether early yield is possible is highly dependent on the kernel. Some kernels will be able to destructively yield (e.g., the kernel must be rerun), some kernels will be able to yield and resume, and some kernels won't be able to yield.

It is noted that the priority processing routines do not have to be populated unless they are to be used. For example, if there is no priority processing to be done, the hardware may simply ignore these branch legs and there would be no action required by the software. Additionally, the commands for priority processing may be dynamically populated and do not need to be known by the ‘normal’ processing a priori. The baseline ‘normal’ processing only needs to know that there is a possibility of pre-emption. For example, two or more classes of priority voxels could use the mechanism of FIG. 9 even if they have highly different subsequent processing needs.

Various examples of the present disclosure may support loops and other complex flows. While most decision trees do not contain loops of kernels, such loops are supported by the proposed concept's control flow capability. Thus, to enable iterative computations and loops within the dataflow execution model, in various examples, the dataflow graph may comprise at least one node of the second type that refers to a preceding node of the dataflow graph, thereby forming a loop. By allowing branching nodes to reference earlier nodes in the graph, the apparatus supports cyclic execution patterns that are useful for iterative algorithms.

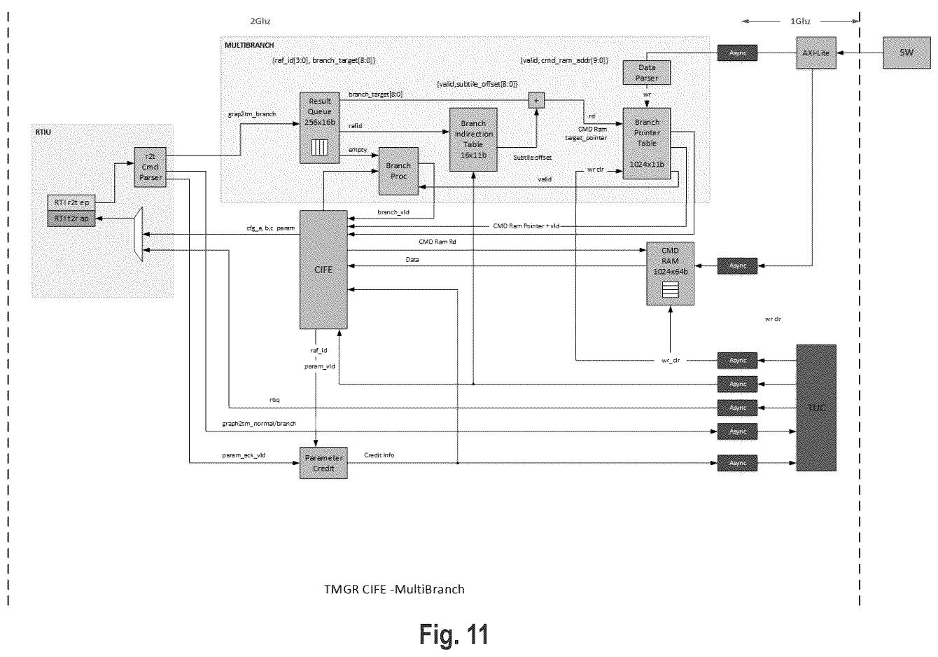

For example, in some decision trees, the use of a neural network for signal classification and subsequent demodulation introduces an interesting opportunity for the introduction of loops and other complex flows, as illustrated in FIG. 10. FIG. 10 shows a hypothetical decision “tree” involving a complex looping structure. Here, multiple decoding attempts may be made based on the dynamic characterization of the voxel and voxel history. Multiple considerations are at play in this sort of decision tree.

First, the neural network is a costly operation, which may be avoided if possible. In particular, the neural network is likely to be an order of magnitude (or more) more computation than demodulating the packet. Thus, if there is a reasonable guess as to what a voxel modulation is based on other characteristics, it may be profitable to attempt to directly demodulate it rather than classify it. Multiple voxel types may be present in a band. For example, a set of demodulations may be attempted for voxels appearing in a given band, and these demodulations applied sequentially in the hope of achieving a correct demodulation. If demodulation fails, which suggests an anomalous voxel, the classifier may be consulted. Classification itself is inherently uncertain. The classifier can return multiple results for a given signal, and therefore one could potentially attempt multiple demodulations in a prioritized order.

In both of the above cases, dynamic loop iteration controls may be used based on system status and voxel characteristics. In other words, a number of iterations of the loop may be dynamically controlled based on at least one of the system status or a characteristic of the data being processed. This dynamic control mechanism enables the semiconductor apparatus to adjust computational workflows based on actual runtime conditions, thereby improving efficiency and adaptability. For example, a variable number of demodulations may be applied based on system load. These controls are coarse-grained and occur at the level of the decision tree and its kernels. The CSA fabric also supports finer-grained dynamic flow control (e.g., traditional instruction-level loop constructs and nests) within kernels.

The semiconductor apparatus' generalized flow control appears to enable the description of a complex decision tree such as the hypothetical tree shown in FIG. 10, simply by way of branching support to arbitrary command packets. For example, in FIG. 10, a table of demodulations to apply based on the band may be provided. The “process list” kernel may iterate across this list trying different demodulators. Upon list exhaustion, without a successful demodulation, the flow may be steered to the classifier. In practice, this processing is really nothing more than a 3-way branch dependent on demodulation success and list termination.

This means that such a flow may be autonomously executed entirely within the CSA processor, enabling low-latency decision-making in the fabric and fabric-driven reconfiguration across the entire flow. This may represent a considerable latency advantage relative to less autonomous approaches, relying on loosely-coupled decision-making occurring on a distant control processor. Additionally, the complexity of this flow illustrates that the baseline branching mechanism will be sufficient to handle essentially arbitrary decision ‘tree’ control flows.

FIG. 11 illustrates a low-level microarchitectural view of the fast-branching architecture. In the “MULTIBRANCH” block, a result queue, a branch processor, a branch indirection table and a branch pointer table may implement the branch functionality. In addition, in the “RTIU” block, a differentiation between nodes of the first and second type may be made.

An emulation-based characterization of fast switching and branching was computed based on the RTL (Register Transfer Layer) code and emulation. The characterization of this flow focuses on branching, as this is approximately equivalent to a non-branch flow in the CSA architecture in terms of configuration latency. This section represents the current state of CSA RTL in simulation and emulation. To characterize the branch flow, multiple scenarios were tested, which are designed to validate modelling-based projections. While a variety of scenarios were evaluated to better understand the behavior of the configuration microarchitecture, it is expected that all practical use cases in signal processing may achieve near-minimum latency. At a high level, the results show a path to meet switching targets in all cases.

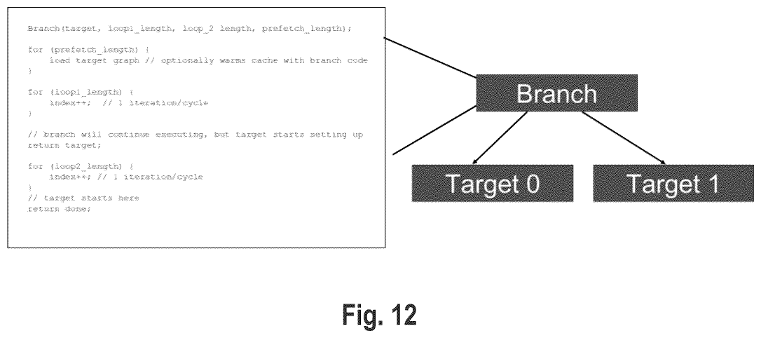

To time the branch flow, both RTL validation environment (simulation) and RTL emulation were used. Simulation was used to collect most results, and emulation was used to validate some results. In general, it is considered a failure in the emulation environment/tooling if the emulation environment does not match the simulation environment. The branch flow was exercised using the topology shown in FIG. 12. FIG. 12 shows the branching flow test topology. This code tests a binary branch, with the branch graph selecting either target 0 or target 1 as the branch target, with the actual branch choice provided as a parameter to the branch graph, rather than the target being chosen based on some computation. The branch graph itself has three loops. The first loop warms the cache with the code segment of target 0. This allows us to evaluate the efficiency of hardware-supported DMA (Direct Memory Access). The second loop is a cycle delay prior to the branch target being returned to the tile manager. This loop allows us to test the minimum graph execution time at which latencies, such as firmware, are exposed. When the branch target is returned, the CSA begins to configure the target graph, even if the branch graph has not completed execution. Finally, the branch graph then has a delay loop that runs for some cycles, enabling us to evaluate the effect of t_{delay} in practice. Such a delay will be observed in many codes; for example, we may make a branch decision based on seeing power in a bin of an FFT, but may still complete the FFT—to find other power loci-before branching to an analysis routine.

At first glance, it may seem that the test case does not represent a wide range of signal processing and decision tree scenarios: it only supports two branches, makes no computation-based branch decision, and the target branches are relatively simple. In reality, the semiconductor apparatus (e.g., CSA) hardware has remarkably robust support for wide branching—it can support fast branching to targets up to the cache's structural limits, with all branch targets observing approximately the same configuration latency. For metadata, 128 branch target slots were provisioned, and the semiconductor apparatus cache targets two megabytes of storage. This may enable handling of branches with up to 128 legs at minimum latency, while wider branches may incur longer latency in some situations. The branch target storage can be made larger with minimum performance/area loss. Partial configuration execution means that observed configuration-to-execution latencies are largely invariant with respect to graph size.

Graphs not localized to/cached in the CSA processor may reside in on-chip memory, which is tens of megabytes in size and could store thousands of graphs. As demonstrated in FIG. 12, even non-localized graphs are compliant at the high-operating point.

The following results are mostly derived from the RTL validation environment. Configuration latencies have been performance-validated in emulation and have been found to match the validation environment, as expected.

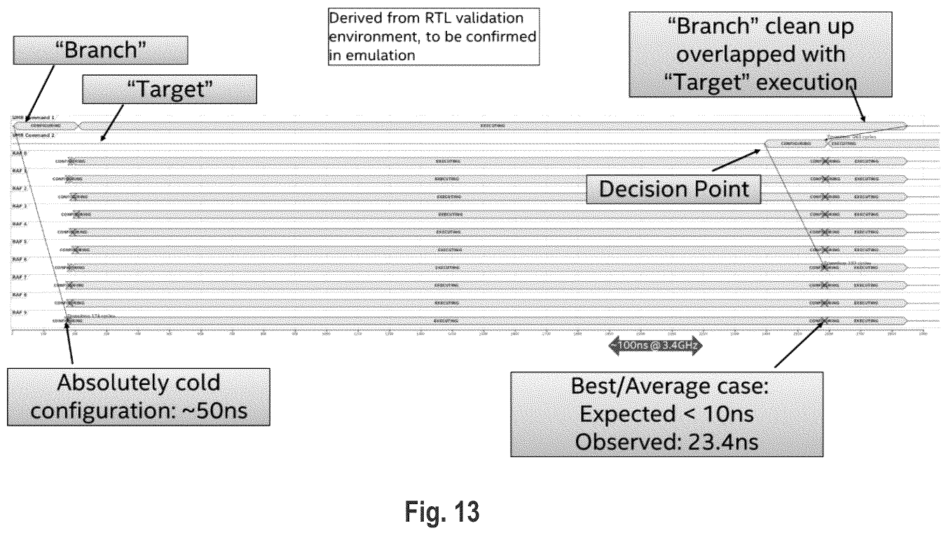

FIG. 13 shows a timing waveform of a branch graph and a target graph, including the fast switch to the target graph. Timings are exact based on RTL execution. Here, no caching is assumed for either the branch or target graphs; such caching would improve observed latency in the case of the branch, but not the target. FIG. 13 examines a branching flow, which is set up to exhibit best and worst case switching latencies. To achieve worst case switching latency, no graph data is prefetched and the full memory latency is exposed on the switch. In this scenario, neither the “branch” graph nor the “target” graph has locality in the cache. Locality generally improves observed latency, but locality can be latency neutral. For the branch graph, command-to-execution latency was measured at ˜174 cycles, which is about 50 nanoseconds at the high operating point. The non-cached case is not expected to be common, as the scheduler or the configuration hardware is expected to be able to warm the cache in advance of most executions, including decision tree branches.

On the right hand side of FIG. 13, a branch flow is shown. The “branch” graph is set up to execute some cycles past the branch to demonstrate a best/average case branching flow. The best case is claimed as an average case because the scheduler has demonstrated an ability to look-ahead and set up the decision tree in CSA sufficiently to guarantee these best-case timings. Turning to the branch, as the decision point is presented prior to the completion of the “branch” graph, the configuration hardware is able to execute the branch and begin configuration of the “target” graph while the “branch” graph is completing its execution. As a result, when the “branch” graph completes, configuration of the “target” graph is already available near the EXA (Execution Array) and can be injected with minimal delay.

Clean-up activities for the “branch” graph may be overlapped with target graph execution, again improving the utilization of the array hardware. These activities may be executed on the tile microcontroller, may include returning results to software, and are examples of activities that could be moved to hardware execution in the future.

Metadata and Graph Caching: Configuration latency combines several factors, but the largest contributors are the memory access latencies of two graph binary components: the graph metadata and the graph itself. These occur serially during a configuration, as the metadata is needed to locate the graph in memory. Metadata caching at the TUC effectively removes the metadata fetch latency from the overall configuration latency, as the graph metadata can be accessed in a relatively small number of cycles.

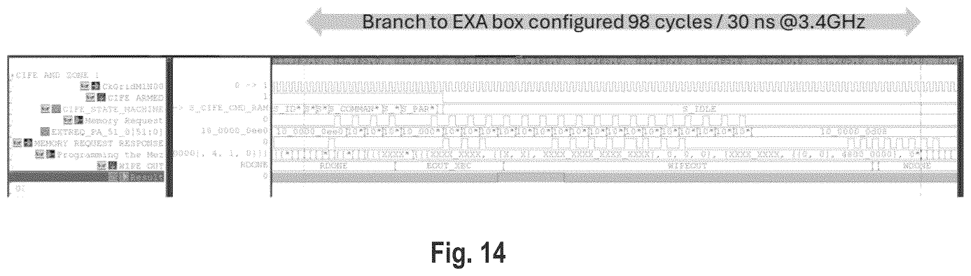

FIG. 14 shows an RTL-derived waveform timing of a branch with data locality in the CSA processor. FIG. 14 examines a branch flow under the following conditions: metadata of the branch target is cached in the metadata cache, and a portion of the graph binary (˜4 KB) is cached in the CSA cache. In this case, the overall configuration latency is reduced by approximately 20 ns relative to the baseline in FIG. 13, due to the removal of memory latency from the configuration process.

The interface circuitry 102 or means for communicating 102 corresponds to one or more inputs and/or outputs designed to receive and/or transmit information. This information can be in digital (bit) values according to a specified code, whether exchanged within a module, between different modules, or even between modules of distinct entities. For example, the interface circuitry 102 or means for communicating 102 may include interface circuitry configured to handle the reception and/or transmission of such information.

For example, the processor circuitry 103 or means for processing 103 can be implemented using one or more processing units, processing devices, or any means for processing, such as a processor, a computer, or a programmable hardware component equipped with appropriately adapted software. Thus, the described function of the processor circuitry 103 or means for processing 103 can be executed in software, running on one or more programmable hardware components. Such components may include a general-purpose processor, a Digital Signal Processor (DSP), a microcontroller, and more.

In at least some embodiments, the memory circuitry 104 or means for storing information 104 may comprise at least one element of the group of a computer readable storage medium, such as an magnetic or optical storage medium, e.g. a hard disk drive, a flash memory, Floppy-Disk, Random Access Memory (RAM), Programmable Read Only Memory (PROM), Erasable Programmable Read Only Memory (EPROM), an Electronically Erasable Programmable Read Only Memory (EEPROM), or a network storage.

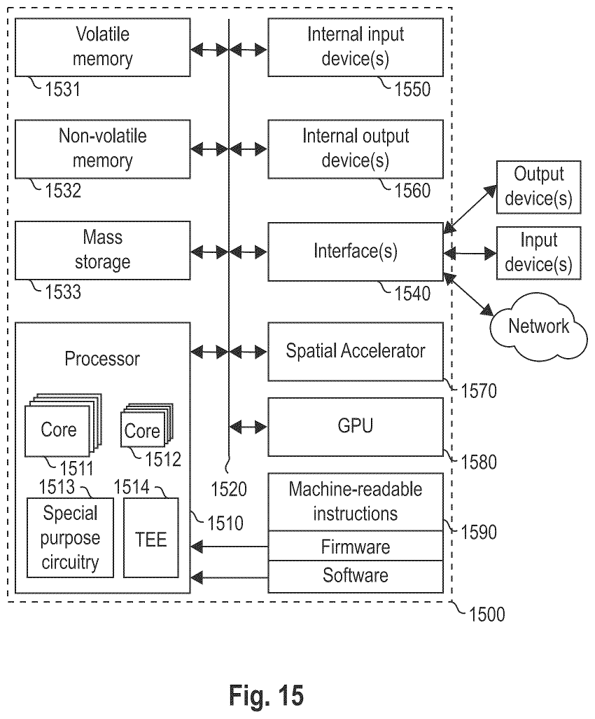

More details and aspects of the semiconductor apparatus 30, semiconductor device 30, computer system 100, and the corresponding methods and computer programs are mentioned in connection with the proposed concept or one or more examples described above or below (e.g., FIG. 15). The semiconductor apparatus 30, semiconductor device 30, computer system 100, and the corresponding methods and computer programs may comprise one or more additional optional features corresponding to one or more aspects of the proposed concept or one or more examples described above or below.

FIG. 15 shows a block diagram of an example computer system 1500 or computing device 1500 structured to execute and/or instantiate the machine-readable instructions and/or operations of FIGS. 1a to 14 to implement the computer system 100 and/or semiconductor apparatus or device 30. The computer system 1500 or computing device 1500 may be, for example, a server, a personal computer, a workstation, a self-learning machine (e.g., a neural network), a mobile device (e.g., a cell phone, a smartphone, a tablet such as an iPad™), a personal digital assistant (PDA), an Internet appliance, a DVD player, a CD player, a digital video recorder, a Blu-ray player, a gaming console, a personal video recorder, a set-top box, a headset (e.g., an augmented reality (AR) headset, a virtual reality (VR) headset, etc.) or other wearable device, or any other type of computing device.

The computer system 1500 or computing device 1500 of the illustrated example includes processor circuitry 1510. The processor circuitry 1510 of the illustrated example is hardware. For example, the processor circuitry 1510 can be implemented by one or more integrated circuits, logic circuits, FPGAs (Field-Programmable Gate Array), microprocessors, CPUs (Central Processing Units), GPUs (Graphics Processing Units), DSPs (Digital Signal Processors), and/or microcontrollers from any desired family or manufacturer. The processor circuitry 1510 may be implemented by one or more semiconductor-based (e.g., silicon-based) devices. For example, the processor circuitry 1510 may provide the functionality of the computer system 1500 or computing device 1500.

The processor circuitry 1510 comprises one or more processor cores 1511, 1512. For example, the processor circuitry 1510 may have heterogeneous cores. Heterogeneous cores in CPUs refer to the use of different types of cores within a single processor, typically combining high-performance (BIG) cores with power-efficient (LITTLE) cores. Thus, the processor circuitry 1510 may comprise one or more BIG cores 1511 and one or more LITTLE cores 1512. BIG cores are designed for performance-intensive tasks and provide higher processing power, but they consume more energy. LITTLE cores, on the other hand, are optimized for energy efficiency and handle less demanding tasks to prolong battery life and reduce power consumption.

The processor circuitry 1510 of the illustrated example is in communication, e.g., via one or more bus interfaces 1520, with a main memory including a volatile memory 1531 and a non-volatile memory 1532. The volatile memory 1531 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1532 may be implemented by flash memory and/or any other desired type of memory device. Access to the main memory 1531, 1532 of the illustrated example is controlled by a memory controller, which may be implemented by special-purpose circuitry 1513 of the processor circuitry 1510.

The computer system 1500 or computing device 1500 of the illustrated example also includes one or more mass storage devices 1533 to store software and/or data. Examples of such mass storage devices 1533 include magnetic storage devices, optical storage devices, floppy disk drives, HDDs, CDs, Blu-ray disk drives, redundant array of independent disks (RAID) systems, solid state storage devices such as flash memory devices, and DVD drives.

The computer system 1500 or computing device 1500 of the illustrated example also includes interface circuitry 1540. The interface circuitry 1540 may be implemented by hardware in accordance with any type of interface standard, such as an Ethernet interface, a WiFi interface, a cellular modem, a universal serial bus (USB) interface, a Bluetooth® interface, a near field communication (NFC) interface, a PCI (Peripheral Component Interconnect) interface, and/or a PCIe (Peripheral Component Interconnect Express) interface. For example, the interface circuitry 1540 of the illustrated example may include a communication device such as a transmitter, a receiver, a transceiver, a modem, a residential gateway, a wireless access point, and/or a network interface to facilitate exchange of data with external machines (e.g., computing devices of any kind) by a network. The communication can be by, for example, an Ethernet connection, a digital subscriber line (DSL) connection, a telephone line connection, a coaxial cable system, a satellite system, a line-of-site wireless system, a cellular telephone system, an optical connection, etc.

In the illustrated example, one or more internal input devices 1550 and/or one or more external input devices are connected to the interface circuitry 1540 or the bus 1520. The input device(s) permit a user to enter data and/or commands into the processor circuitry 1510. The input device(s) can be implemented by, for example, an audio sensor, a microphone, a camera (still or video), a keyboard, a button, a mouse, a touchscreen, a trackpad, a trackball, an isopoint device, and/or a voice recognition system.

One or more internal output devices 1560 and/or one or more external output devices are also connected to the interface circuitry 1540 of the illustrated example. The output devices 1560 can be implemented, for example, by display devices (e.g., a light emitting diode (LED), an organic light emitting diode (OLED), a liquid crystal display (LCD), a cathode ray tube (CRT) display, an in-plane switching (IPS) display, a touchscreen, etc.), a tactile output device, a printer, and/or speaker. The computer system 1500 or computing device 1500 of the illustrated example, thus, typically includes a graphics driver card, a graphics driver chip, and/or graphics processor circuitry such as a GPU 1513, 1580, which may correspond to or be part of the processor circuitry 1510, for example as special purpose circuitry 1513 or as cores 1511, 1512, or separate from the processor 1510, for example as a separate GPU 1580.

The computer system 1500 or computing device 1500 of the illustrated example may include a Spatial Accelerator 1570 (e.g., the semiconductor apparatus or device 30). For example, the Spatial Accelerator 1570 may be configured to improve the computational speed and efficiency of specific tasks by executing parallel processing operations tailored to the respective tasks. The Spatial Accelerator 1570 may include hardware such as Processing Elements and an Interconnect Network designed to handle large volumes of data with low latency. For example, the Processor 1510, the Spatial Accelerator 1570 (e.g., the semiconductor apparatus or device 30), the integrated GPU 1513, and/or the dedicated GPU 1580 may be considered xPUs (x Processing Units, where x is a placeholder) of the computer system 700 or computing device 700.

The computer system 1500 or computing device 1500 of the illustrated example includes machine-readable instructions 1590. For example, the machine-readable instructions may be part of firmware or software of the computer system 1500 or computing device 1500. The machine-readable instructions 1590 may be stored in the mass storage device 1533, in the volatile memory 1531, in the non-volatile memory 1532, and/or on a removable non-transitory computer-readable storage medium such as a CD or DVD.

### In the Following, Some Examples of the Proposed Concept are Presented:

An example (e.g., example 1) relates to a semiconductor apparatus comprising interface circuitry for obtaining a dataflow graph comprising a plurality of nodes, and a plurality of processing elements, an interconnect network coupled to the plurality of processing elements and configured to receive an input of the dataflow graph, wherein the dataflow graph is to configure the interconnect network and the plurality of processing elements, wherein the processing elements are to perform a plurality of operations defined by the nodes of dataflow graph, wherein the dataflow graph comprises a first type of node for performing a computation and a second type of node for determining a branching condition, wherein the semiconductor apparatus is configured to, upon determining a result of a branching condition specified by a node having the second type, configure the interconnect network and the processing elements based on the result of the branching condition.
Another example (e.g., example 2) relates to a previous example (e.g., example 1) or to any other example, further comprising that the nodes of the dataflow graph are stored in a command queue, and the semiconductor apparatus is configured to jump from the branching-condition node to an entry in a branch table being separate from the command queue.
Another example (e.g., example 3) relates to a previous example (e.g., example 2) or to any other example, further comprising that the entry in the branch table defines an offset with respect to a command memory for referencing nodes of the dataflow graph or of a different dataflow graph.
Another example (e.g., example 4) relates to a previous example (e.g., example 3) or to any other example, further comprising that the semiconductor apparatus is configured to configure the interconnect network and the processing elements based on the entry in the branch table and the offset with respect to the command memory.
Another example (e.g., example 5) relates to a previous example (e.g., one of the examples 2 to 4) or to any other example, further comprising that the branch table is configured to support nested branching by specifying a node referred to by an entry in the branch table that is also a node of the second type for determining a further branching condition.
Another example (e.g., example 6) relates to a previous example (e.g., one of the examples 1 to 5) or to any other example, further comprising that the semiconductor apparatus comprises a cache memory, wherein the semiconductor apparatus is configured to pre-fetch operations associated with nodes being referred to by the branching-condition node into the cache memory.
Another example (e.g., example 7) relates to a previous example (e.g., one of the examples 1 to 6) or to any other example, further comprising that the semiconductor apparatus is configured to initiate the configuration of the interconnect network and the processing elements based on the result of the branching condition before an execution of the dataflow graph containing the node of the second type has completed.
Another example (e.g., example 8) relates to a previous example (e.g., example 7) or to any other example, further comprising that a decision result packet indicating the result of the branching condition is configured to bypass a result queue to trigger the configuration of the interconnect network and the processing elements
Another example (e.g., example 9) relates to a previous example (e.g., one of the examples 1 to 8) or to any other example, further comprising that the semiconductor apparatus comprises a request-address file circuitry configured to configure the interconnect network and the processing elements based on the result of the branching condition.
Another example (e.g., example 10) relates to a previous example (e.g., one of the examples 1 to 9) or to any other example, further comprising that the branching condition specifies two or more nodes of the dataflow graph or of one or more different dataflow graphs to be used for configuring the interconnect network and the processing elements.
Another example (e.g., example 11) relates to a previous example (e.g., one of the examples 1 to 10) or to any other example, further comprising that the dataflow graph comprises at least one node of the second type referring to a preceding node of the dataflow graph, thereby forming a loop.
Another example (e.g., example 12) relates to a previous example (e.g., example 11) or to any other example, further comprising that a number of iterations of the loop is dynamically controlled based on at least one of a system status and a characteristic of data being processed.
Another example (e.g., example 13) relates to a previous example (e.g., one of the examples 1 to 12) or to any other example, further comprising that the semiconductor apparatus is configured to pre-empt execution of one or more nodes of the dataflow graph based on the result of the branching condition.
Another example (e.g., example 14) relates to a previous example (e.g., example 13) or to any other example, further comprising that pre-emption is implemented by evaluating the result of a branching condition after execution of a first-type node, with the branching condition being related to the pre-emption.
Another example (e.g., example 15) relates to a previous example (e.g., one of the examples 13 or 14) or to any other example, further comprising that the pre-emption is triggered by polling a memory location to be set by a scheduler to indicate a need for pre-emption.
An example (e.g., example 16) relates to a semiconductor device comprising an interface for obtaining a dataflow graph comprising a plurality of nodes, and a plurality of processing elements, an interconnect network coupled to the plurality of processing elements and configured to receive an input of the dataflow graph, wherein the dataflow graph is to configure the interconnect network and the plurality of processing elements, wherein the processing elements are to perform a plurality of operations defined by the nodes of dataflow graph, wherein the dataflow graph comprises a first type of node for performing a computation and a second type of node for determining a branching condition, wherein the semiconductor device is configured to, upon determining a result of a branching condition specified by a node having the second type, configure the interconnect network and the processing elements based on the result of the branching condition.
Another example (e.g., example 17) relates to a previous example (e.g., example 16) or to any other example, further comprising that the nodes of the dataflow graph are stored in a command queue, and the semiconductor device is configured to jump from the branching-condition node to an entry in a branch table being separate from the command queue.
Another example (e.g., example 18) relates to a previous example (e.g., example 17) or to any other example, further comprising that the entry in the branch table defines an offset with respect to a command memory for referencing nodes of the dataflow graph or of a different dataflow graph.
Another example (e.g., example 19) relates to a previous example (e.g., example 18) or to any other example, further comprising that the semiconductor device is configured to configure the interconnect network and the processing elements based on the entry in the branch table and the offset with respect to the command memory.
Another example (e.g., example 20) relates to a previous example (e.g., one of the examples 17 to 19) or to any other example, further comprising that the branch table is configured to support nested branching by specifying a node referred to by an entry in the branch table that is also a node of the second type for determining a further branching condition.
Another example (e.g., example 21) relates to a previous example (e.g., one of the examples 16 to 20) or to any other example, further comprising that the semiconductor device comprises a cache memory, wherein the semiconductor device is configured to pre-fetch operations associated with nodes being referred to by the branching-condition node into the cache memory.
Another example (e.g., example 22) relates to a previous example (e.g., one of the examples 16 to 21) or to any other example, further comprising that the semiconductor device is configured to initiate the configuration of the interconnect network and the processing elements based on the result of the branching condition before an execution of the dataflow graph containing the node of the second type has completed.
Another example (e.g., example 23) relates to a previous example (e.g., example 22) or to any other example, further comprising that a decision result packet indicating the result of the branching condition is configured to bypass a result queue to trigger the configuration of the interconnect network and the processing elements
Another example (e.g., example 24) relates to a previous example (e.g., one of the examples 16 to 23) or to any other example, further comprising that the semiconductor device comprises a request-address file circuitry configured to configure the interconnect network and the processing elements based on the result of the branching condition.
Another example (e.g., example 25) relates to a previous example (e.g., one of the examples 16 to 24) or to any other example, further comprising that the branching condition specifies two or more nodes of the dataflow graph or of one or more different dataflow graphs to be used for configuring the interconnect network and the processing elements.
Another example (e.g., example 26) relates to a previous example (e.g., one of the examples 16 to 25) or to any other example, further comprising that the dataflow graph comprises at least one node of the second type referring to a preceding node of the dataflow graph, thereby forming a loop.
Another example (e.g., example 27) relates to a previous example (e.g., example 26) or to any other example, further comprising that a number of iterations of the loop is dynamically controlled based on at least one of a system status and a characteristic of data being processed.
Another example (e.g., example 28) relates to a previous example (e.g., one of the examples 16 to 27) or to any other example, further comprising that the semiconductor device is configured to pre-empt execution of one or more nodes of the dataflow graph based on the result of the branching condition.
Another example (e.g., example 29) relates to a previous example (e.g., example 28) or to any other example, further comprising that pre-emption is implemented by evaluating the result of a branching condition after execution of a first-type node, with the branching condition being related to the pre-emption.
Another example (e.g., example 30) relates to a previous example (e.g., one of the examples 28 or 29) or to any other example, further comprising that the pre-emption is triggered by polling a memory location to be set by a scheduler to indicate a need for pre-emption.
An example (e.g., example 31) relates to a method for a semiconductor device comprising obtaining a dataflow graph comprising a plurality of nodes, wherein the dataflow graph is to configure an interconnect network coupled to a plurality of processing elements and the plurality of processing elements, wherein the processing elements are to perform a plurality of operations defined by the nodes of dataflow graph, wherein the dataflow graph comprises a first type of node for performing a computation and a second type of node for determining a branching condition, wherein the method comprises, by the semiconductor device, upon determining a result of a branching condition specified by a node having the second type, configuring the interconnect network and the processing elements based on the result of the branching condition.
Another example (e.g., example 32) relates to a previous example (e.g., example 31) or to any other example, further comprising that the nodes of the dataflow graph are stored in a command queue, and the method comprises, by the semiconductor device, jumping from the branching-condition node to an entry in a branch table being separate from the command queue.
Another example (e.g., example 33) relates to a previous example (e.g., example 32) or to any other example, further comprising that the entry in the branch table defines an offset with respect to a command memory for referencing nodes of the dataflow graph or of a different dataflow graph.
Another example (e.g., example 34) relates to a previous example (e.g., example 33) or to any other example, further comprising that the method comprises, by the semiconductor device, configuring the interconnect network and the processing elements based on the entry in the branch table and the offset with respect to the command memory.
Another example (e.g., example 35) relates to a previous example (e.g., one of the examples 32 to 34) or to any other example, further comprising that the branch table is configured to support nested branching by specifying a node referred to by an entry in the branch table that is also a node of the second type for determining a further branching condition.
Another example (e.g., example 36) relates to a previous example (e.g., one of the examples 31 to 35) or to any other example, further comprising that the method comprises, by the semiconductor device, pre-fetching (130) operations associated with nodes being referred to by the branching-condition node into a cache memory of the semiconductor device.
Another example (e.g., example 37) relates to a previous example (e.g., one of the examples 31 to 36) or to any other example, further comprising that the method comprises, by the semiconductor device, initiating the configuration (160) of the interconnect network and the processing elements based on the result of the branching condition before an execution of the dataflow graph containing the node of the second type has completed.
Another example (e.g., example 38) relates to a previous example (e.g., example 37) or to any other example, further comprising that a decision result packet indicating the result of the branching condition is configured to bypass a result queue to trigger the configuration of the interconnect network and the processing elements
Another example (e.g., example 39) relates to a previous example (e.g., one of the examples 31 to 38) or to any other example, further comprising that at least a portion of the method is performed by a request-address file circuitry of the semiconductor device that is configured to configure the interconnect network and the processing elements based on the result of the branching condition.
Another example (e.g., example 40) relates to a previous example (e.g., one of the examples 31 to 39) or to any other example, further comprising that the branching condition specifies two or more nodes of the dataflow graph or of one or more different dataflow graphs to be used for configuring the interconnect network and the processing elements.
Another example (e.g., example 41) relates to a previous example (e.g., one of the examples 31 to 40) or to any other example, further comprising that the dataflow graph comprises at least one node of the second type referring to a preceding node of the dataflow graph, thereby forming a loop.
Another example (e.g., example 42) relates to a previous example (e.g., example 41) or to any other example, further comprising that a number of iterations of the loop is dynamically controlled based on at least one of a system status and a characteristic of data being processed.
Another example (e.g., example 43) relates to a previous example (e.g., one of the examples 31 to 42) or to any other example, further comprising that the method comprises, by the semiconductor device, pre-empting (150) execution of one or more nodes of the dataflow graph based on the result of the branching condition.
Another example (e.g., example 44) relates to a previous example (e.g., example 43) or to any other example, further comprising that pre-emption is implemented by evaluating the result of a branching condition after execution of a first-type node, with the branching condition being related to the pre-emption.
Another example (e.g., example 45) relates to a previous example (e.g., one of the examples 43 or 44) or to any other example, further comprising that the pre-emption is triggered by polling a memory location to be set by a scheduler to indicate a need for pre-emption.
An example (e.g., example 46) relates to a non-transitory computer-readable medium storing instructions that, when executed by one or more processing circuitries, cause the one or more processing circuitries to perform a method for a computer system, the method comprising determining (110) a dataflow graph for a semiconductor apparatus, the semiconductor apparatus comprising a plurality of processing elements and an interconnect network between the plurality of processing elements to receive an input of the dataflow graph, wherein the dataflow graph comprises a first type of node for performing a computation and a second type of node for determining a branching condition.
Another example (e.g., example 47) relates to a previous example (e.g., example 46) or to any other example, further comprising that the branching condition specifies two or more nodes of the dataflow graph or of one or more different dataflow graphs to be used for configuring the interconnect network and the processing elements.
Another example (e.g., example 48) relates to a previous example (e.g., one of the examples 46 or 47) or to any other example, further comprising that the dataflow graph comprises at least one node of the second type referring to a preceding node of the dataflow graph, thereby forming a loop.
An example (e.g., example 49) relates to a method for a computer system, the method comprising determining a dataflow graph for a semiconductor apparatus, the semiconductor apparatus comprising a plurality of processing elements and an interconnect network between the plurality of processing elements to receive an input of the dataflow graph, wherein the dataflow graph comprises a first type of node for performing a computation and a second type of node for determining a branching condition.
Another example (e.g., example 50) relates to a previous example (e.g., example 49) or to any other example, further comprising that the branching condition specifies two or more nodes of the dataflow graph or of one or more different dataflow graphs to be used for configuring the interconnect network and the processing elements.
Another example (e.g., example 51) relates to a previous example (e.g., one of the examples 49 or 50) or to any other example, further comprising that the dataflow graph comprises at least one node of the second type referring to a preceding node of the dataflow graph, thereby forming a loop.
Another example (e.g., example 52) relates to an apparatus for a computer system, comprising interface circuitry, machine-readable instructions, and processor circuitry to execute the machine-readable instructions to perform the method according to example one of the examples 49 to 51.
Another example (e.g., example 53) relates to a device for a computer system, comprising means for communicating, machine-readable instructions, and means for processing to execute the machine-readable instructions to perform the method according to one of the example 49 to 52.
Another example (e.g., example 54) relates to a computer system comprising the semiconductor apparatus or semiconductor device according to one of the examples 1 to 30.
Another example (e.g., example 55) relates to the computer system according to example 54, further comprising the apparatus or device according to one of the examples 52 or 53.

The aspects and features described in relation to a particular one of the previous examples may also be combined with one or more of the further examples to replace an identical or similar feature of that further example or to additionally introduce the features into the further example.

Examples may further be or relate to a (computer) program including a program code to execute one or more of the above methods when the program is executed on a computer, processor or other programmable hardware component. Thus, steps, operations or processes of different ones of the methods described above may also be executed by programmed computers, processors or other programmable hardware components. Examples may also cover program storage devices, such as digital data storage media, which are machine-, processor- or computer-readable and encode and/or contain machine-executable, processor-executable or computer-executable programs and instructions. Program storage devices may include or be digital storage devices, magnetic storage media such as magnetic disks and magnetic tapes, hard disk drives, or optically readable digital data storage media, for example. Other examples may also include computers, processors, control units, (field) programmable logic arrays ((F)PLAs), (field) programmable gate arrays ((F)PGAs), graphics processor units (GPU), application-specific integrated circuits (ASICs), integrated circuits (ICs) or system-on-a-chip (SoCs) systems programmed to execute the steps of the methods described above.

It is further understood that the disclosure of several steps, processes, operations or functions disclosed in the description or claims shall not be construed to imply that these operations are necessarily dependent on the order described, unless explicitly stated in the individual case or necessary for technical reasons. Therefore, the previous description does not limit the execution of several steps or functions to a certain order. Furthermore, in further examples, a single step, function, process or operation may include and/or be broken up into several sub-steps, -functions, -processes or -operations.

If some aspects have been described in relation to a device or system, these aspects should also be understood as a description of the corresponding method. For example, a block, device or functional aspect of the device or system may correspond to a feature, such as a method step, of the corresponding method. Accordingly, aspects described in relation to a method shall also be understood as a description of a corresponding block, a corresponding element, a property or a functional feature of a corresponding device or a corresponding system.

The following claims are hereby incorporated in the detailed description, wherein each claim may stand on its own as a separate example. It should also be noted that although in the claims a dependent claim refers to a particular combination with one or more other claims, other examples may also include a combination of the dependent claim with the subject matter of any other dependent or independent claim. Such combinations are hereby explicitly proposed, unless it is stated in the individual case that a particular combination is not intended. Furthermore, features of a claim should also be included for any other independent claim, even if that claim is not directly defined as dependent on that other independent claim.

What is claimed is:

1. A semiconductor apparatus comprising:
interface circuitry for obtaining a dataflow graph comprising a plurality of nodes; and
a plurality of processing elements;
an interconnect network coupled to the plurality of processing elements and configured to receive an input of the dataflow graph,
wherein the dataflow graph is to configure the interconnect network and the plurality of processing elements, wherein the processing elements are to perform a plurality of operations defined by the nodes of dataflow graph,
wherein the dataflow graph comprises a first type of node for performing a computation and a second type of node for determining a branching condition,
wherein the semiconductor apparatus is configured to, upon determining a result of a branching condition specified by a node having the second type, configure the interconnect network and the processing elements based on the result of the branching condition.

2. The semiconductor apparatus according to claim 1, wherein the nodes of the dataflow graph are stored in a command queue, and the semiconductor apparatus is configured to jump from the branching-condition node to an entry in a branch table being separate from the command queue.

3. The semiconductor apparatus according to claim 2, wherein the entry in the branch table defines an offset with respect to a command memory for referencing nodes of the dataflow graph or of a different dataflow graph.

4. The semiconductor apparatus according to claim 3, wherein the semiconductor apparatus is configured to configure the interconnect network and the processing elements based on the entry in the branch table and the offset with respect to the command memory.

5. The semiconductor apparatus according to claim 2, wherein the branch table is configured to support nested branching by specifying a node referred to by an entry in the branch table that is also a node of the second type for determining a further branching condition.

6. The semiconductor apparatus according to claim 1, wherein the semiconductor apparatus comprises a cache memory, wherein the semiconductor apparatus is configured to pre-fetch operations associated with nodes being referred to by the branching-condition node into the cache memory.

7. The semiconductor apparatus according to claim 1, wherein the semiconductor apparatus is configured to initiate the configuration of the interconnect network and the processing elements based on the result of the branching condition before an execution of the dataflow graph containing the node of the second type has completed.

8. The semiconductor apparatus according to claim 7, wherein a decision result packet indicating the result of the branching condition is configured to bypass a result queue to trigger the configuration of the interconnect network and the processing elements.

9. The semiconductor apparatus according to claim 1, wherein the semiconductor apparatus comprises a request-address file circuitry configured to configure the interconnect network and the processing elements based on the result of the branching condition.

10. The semiconductor apparatus according to claim 1, wherein the branching condition specifies two or more nodes of the dataflow graph or of one or more different dataflow graphs to be used for configuring the interconnect network and the processing elements.

11. The semiconductor apparatus according to claim 1, wherein the dataflow graph comprises at least one node of the second type referring to a preceding node of the dataflow graph, thereby forming a loop.

12. The semiconductor apparatus according to claim 11, wherein a number of iterations of the loop is dynamically controlled based on at least one of a system status and a characteristic of data being processed.

13. The semiconductor apparatus according to claim 1, wherein the semiconductor apparatus is configured to pre-empt execution of one or more nodes of the dataflow graph based on the result of the branching condition.

14. The semiconductor apparatus according to claim 13, wherein pre-emption is implemented by evaluating the result of a branching condition after execution of a first-type node, with the branching condition being related to the pre-emption.

15. The semiconductor apparatus according to claim 13, wherein the pre-emption is triggered by polling a memory location to be set by a scheduler to indicate a need for pre-emption.

16. A method for a semiconductor device comprising:
obtaining a dataflow graph comprising a plurality of nodes,
wherein the dataflow graph is to configure an interconnect network coupled to a plurality of processing elements and the plurality of processing elements,
wherein the processing elements are to perform a plurality of operations defined by the nodes of dataflow graph,
wherein the dataflow graph comprises a first type of node for performing a computation and a second type of node for determining a branching condition,
wherein the method comprises, by the semiconductor device, upon determining a result of a branching condition specified by a node having the second type, configuring the interconnect network and the processing elements based on the result of the branching condition.

17. The method according to claim 16, wherein the nodes of the dataflow graph are stored in a command queue, and the method comprises, by the semiconductor device, jumping from the branching-condition node to an entry in a branch table being separate from the command queue.

18. A non-transitory computer-readable medium storing instructions that, when executed by one or more processing circuitries, cause the one or more processing circuitries to perform a method for a computer system, the method comprising:
determining a dataflow graph for a semiconductor apparatus, the semiconductor apparatus comprising a plurality of processing elements and an interconnect network between the plurality of processing elements to receive an input of the dataflow graph,
wherein the dataflow graph comprises a first type of node for performing a computation and a second type of node for determining a branching condition.

19. The non-transitory computer-readable medium according to claim 18, wherein the branching condition specifies two or more nodes of the dataflow graph or of one or more different dataflow graphs to be used for configuring the interconnect network and the processing elements.

20. The non-transitory computer-readable medium according to claim 18, wherein the dataflow graph comprises at least one node of the second type referring to a preceding node of the dataflow graph, thereby forming a loop.
